(19) United States
(12) Patent Application Publication
(10) Pub. No.: US 2011/0097021 A1
(43) Pub. Date: Apr. 28, 2011

(54) BULLET RESISTANT BACKPACK

(76) Inventors: Joseph Curran, North Billerica, MA (US); Michael Pelonzi, Beverly, MA (US)

(21) Appl. No.: 11/733,743

(22) Filed: Apr. 10, 2007

Related U.S. Application Data
(60) Provisional application No. 60/790,638, filed on Apr. 10, 2006.

(51) Int. Cl. B65D 30/08; A45C 13/00; B32B 5/12

(52) U.S. Cl. 383/109; 190/125; 428/113

(57) ABSTRACT

A lightweight ballistic protection backpack and other useful items are realized utilizing one or more panels of ultra high molecular weight polyethylene (or UHMWPE) unidirectional laminate.

### CROSS-REFERENCE TO CORRESPONDING APPLICATIONS

This application takes priority from provisional patent application Ser. No. 60/790,638 filed on Apr. 10, 2006.

### TECHNICAL FIELD

The present invention relates generally to ballistic protection devices and more specifically to lightweight ballistic protection devices that also function as useful articles such as backpacks, bags, briefcases, seat cushions, etc.

### BACKGROUND OF THE INVENTION

### Background Art

The most common ballistic protection device is the bulletproof vest. These vests have saved the lives of many law enforcement officers and military personnel in recent years. Most modern day ballistic vests include one or more protective panels having overlying layers of a fabric made from woven high tensile strength ballistic resistant polymeric fibers. Woven fabrics made from an aramid fiber known as KEVLAR, for example, have been used successfully in ballistic vests because of the high-energy absorption properties of the fabric material.

Resistance to projectile penetration is a principal factor in designing a ballistic panel. Thicker panels comprising added protective layers can offer greater protection against projectiles having higher threat levels, but added protective layers also add undesired weight and inflexibility. In addition to woven KEVLAR fabric layers, ballistic panels have been made from other high performance synthetic fibers and composites to reduce weight and improve flexibility.

Ballistic panels are regularly certified by ballistics testing to measure their ability to protect against different projectiles fired from different types of weapons at various angles. One ballistic test commonly used in the industry is the National Institute of Justice (NIJ) Standards 0101.03 which, in general terms, is a high performance standard requiring that a ballistic panel prevent penetration of specified rounds fired at velocities up to 1450 ft/sec. In addition to preventing such projectile penetration, “backface deformation” also is a required test factor in the NIJ Standard 0101.03 certification test. Backface deformation indirectly measures the trauma level experienced by a user from a projectile that does not penetrate the test ballistic panel.

In addition to the need for bulletproof vests used by the military and police, with the seeming proliferation of school, office and other random shootings, there is a need for ballistic protection devices that can be used on an everyday basis by students, office workers and other civilians. These devices should be concealable and lightweight enough to be used on a regular basis, even by small children.

Therefore, there is a need to provide bullet resistant devices that use ballistic panels that are reasonably thin and light in weight as compared to ballistic panels currently employed in bulletproof devices. Also, although thinner and lighter than most existing ballistic panels, these ballistic panels must also still be capable of meeting the NIJ high performance projectile test specifications.

The following issued U.S. Patents appear to constitute relevant prior art:

| U.S. PATENT NO. | PATENT DATE | INVENTOR |
|---|---|---|
| 4,830,245 | May 16, 1980 | Arakaki |
| 6,161,738 | Dec. 19, 2000 | Norris |

Arakaki discloses a backpack carrier comprising lightweight metal frame wrapped by a plurality of layers of KEVLAR, which produces a bullet resistant shield.

Norris discloses a container for transporting articles that includes a ballistic shield attached to one or more walls of the container. Norris discloses using a flexible textile material such as KEVLAR or one of a group of rigid materials.

Neither of these patents disclose using a ballistic panel comprising an ultra high molecular weight polyethylene (or UHMWPE) unidirectional laminate.

### SUMMARY OF THE INVENTION

A lightweight ballistic protection backpack is realized utilizing one or more panels of ultra high molecular weight polyethylene (or UHMWPE) unidirectional laminate. UHMWPE, also known as high modulus polyethylene (HMPE) or high performance polyethylene (HPPE) is a thermoplastic. It has extremely long chains, with molecular weight numbering in the millions, usually between 2 and 6 million. The longer chain serves to transfer load more effectively to the polymer backbone by strengthening intermolecular interactions. This results in a very tough material, with the highest impact strength of any thermoplastic presently made.

UHMWPE fibers are made using a DSM patented (1979) method called gel spinning. A precisely heated gel of UHMWPE is processed by an extruder through a spinneret. The extrudate is drawn through the air and then cooled in a water bath. The end result is a fiber with a high degree of molecular orientation, and therefore exceptional tensile strength. To fabricate a UHMWPE ballistic panel, the fibers are generally aligned and bonded into sheets, which are then layered at various angles to give the resulting composite material strength in all directions.

There are several direct advantages of UHMWPE unidirectional panels over a KEVLAR weave/woven design. For example, UHMWPE unidirectional panels, on a pound for pound comparison, are better & stronger in terms of ballistic performance than panels made with KEVLAR type materials. A panel of UHMWPE is 15 times stronger than Steel versus a panel of KEVLAR of the same weight, which is only 5 times stronger than Steel. In addition, UHMWPE unidirectional panels are also more resistant to corrosive chemicals, have extremely low moisture absorption, have very low coefficients of friction, are self-lubricating and are highly resistant to abrasion.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawings in which:

FIG. 1 is a side view of a preferred embodiment of the present invention;

FIG. 2 is a side view of a ballistic resistant panel as incorporated in the invention of FIG. 1;

FIG. 3 is a front view of the ballistic resistant panel of FIG. 2;

FIG. 4 is a rear view of the invention of FIG. 1;

FIG. 5 is a rear view of the invention of FIG. 1 further illustrating the ballistic resistant panel of FIG. 2;

FIG. 6 illustrates an alternative embodiment of the present invention; and

FIG. 7 illustrates a second alternative embodiment of the present invention.

### DETAILED DESCRIPTION OF PREFERRED EMBODIMENTS

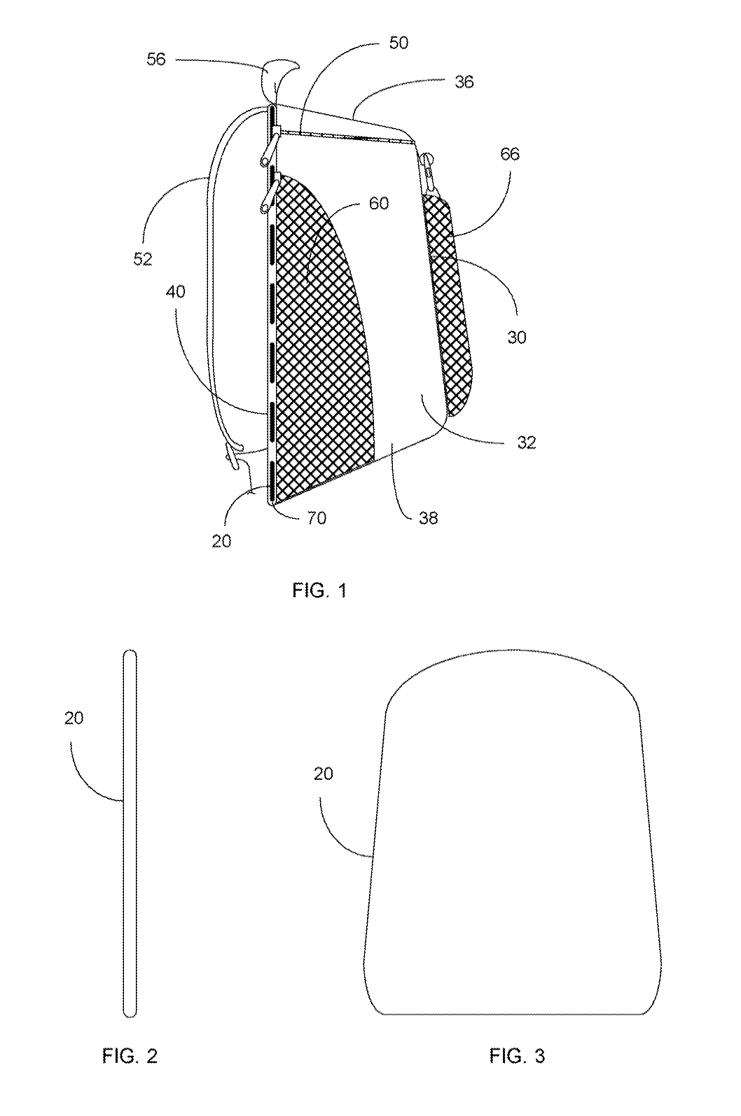

Referring to the accompanying figures and initially FIGS. 1 through 5 in particular, a bullet resistant backpack 10 is shown. As illustrated, the bullet resistant backpack 10 includes at least one bullet resistant panel 20. In certain respects the bullet resistant backpack 10 is similar to most backpacks in that it includes an interior section 28 for transporting objects. The interior section 28 is formed by a front panel 30, a pair of side panels 32, 34, a top panel 36, a bottom panel 38 and a back panel 40.

In the present embodiment, the bullet resistant backpack further includes a zipper 50, which allows the top panel 36 to open and provide access to the interior section 28. Straps 52, 54 and handle 56 allow the user to either carry or wear the backpack. Optional side pouches 60, 62 and front mesh pouch 66 are shown for purposes of example; however, it should be appreciated that any backpack configuration may be used.

In a preferred embodiment, the bullet resistant panel 20 comprises a plurality of layers of lightweight composite material such as ultra high molecular weight polyethylene unidirectional (“UHMWPE”) laminations. The bullet resistant panel 20 as shown is either removably or permanently incorporated into a sleeve 70, which is operatively connected to the back panel 40. Other embodiments for securing the bullet resistant panel 20 within or on the outside of the backpack 10 are contemplated such as Velcro, snaps, glue, etc.

In certain embodiments additional bullet resistant panels may be incorporated in or attached to the front panel 30, side panels 32, 34 and or top and bottom panels 36, 38. In preferred embodiments the bullet resistant panel 20 should be sufficient by itself to stop most types of ammunition used in random shootings yet light enough that even the youngest of students that typically carry a backpack to school could carry a bag employing bullet resistant panel 20 without much additional effort.

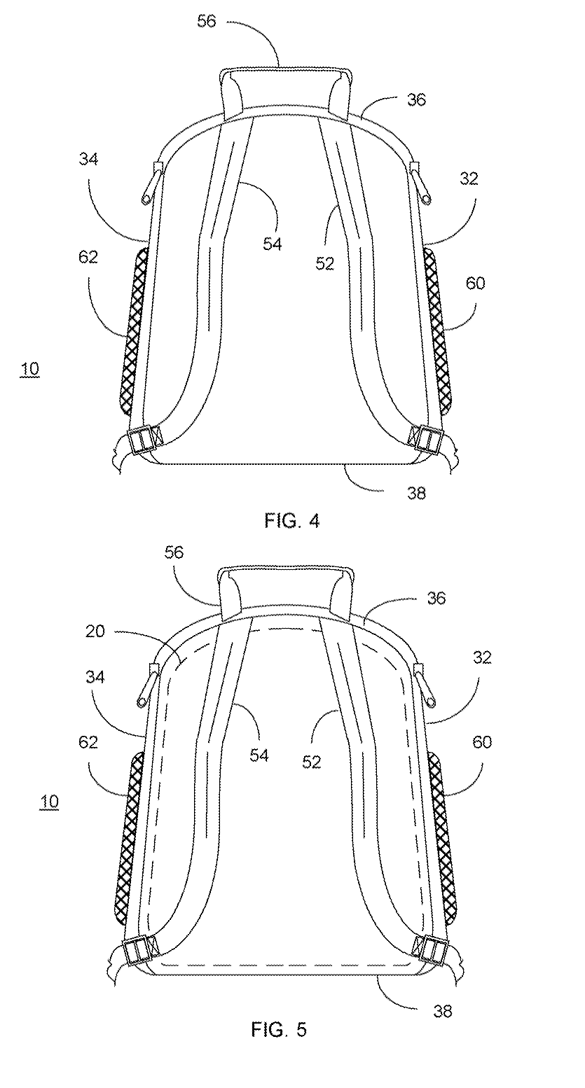

Referring now to FIGS. 4 and 5, the back panel 40 is shown wherein the bullet resistant panel 20 incorporated therein. It should be noted that in a preferred embodiment of the present invention the bullet resistant panel 20 covers as much of the cross sectional surface of the back panel 40 as is practicable, which provides for a larger ballistic shield, however, smaller profiles are contemplated.

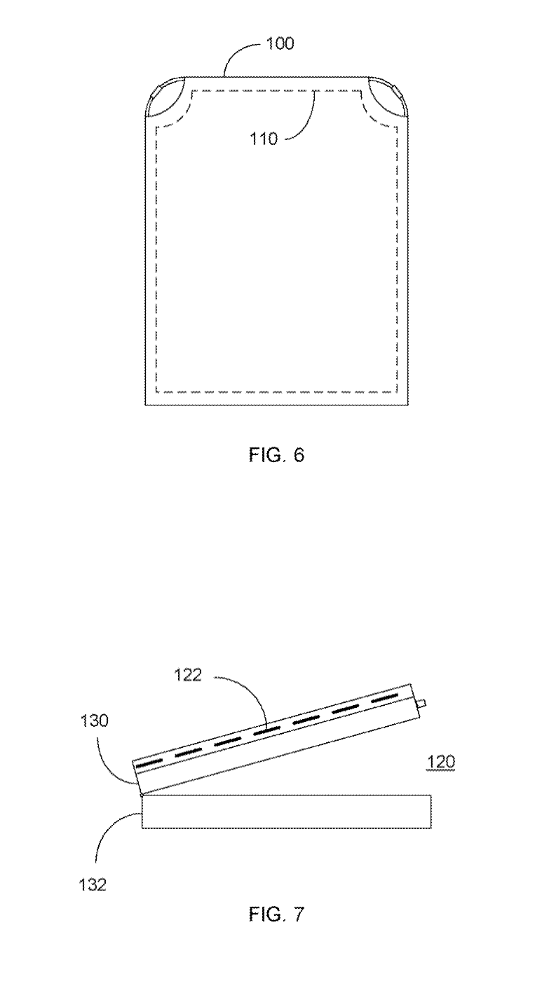

Referring now to FIGS. 6 and 7, other everyday carryable items are shown that include bullet resistant panels similar to the bullet resistant panel 20. As shown in FIG. 6, a seat cushion 100 includes a bullet resistant panel 110. The bullet resistant panel 110 preferably comprises the same characteristic properties as those of the bullet resistant panel 20 and is therefore thin and lightweight. Because of the lightweight and thin properties of the bullet resistant panel 110, the seat cushion 100 can comfortably be carried to sporting events and other outings while concealing the presence of the bullet resistant panel. In addition, the seat cushion 100 can be used in a car, on a boat or in an office environment.

A briefcase 120 includes at least one bullet resistant panel 122 operatively positioned within a top panel 130. The bullet resistant panel could also be incorporated within a bottom panel 132. Again, because of the lightweight and thin properties of the bullet resistant panel 122 the briefcase 120 can be utilized just like any other briefcase without adding significant fatigue to the user.

Various aspects of the disclosed embodiments have been omitted to avoid obfuscation of the more salient features. By way of example, it will be understood that the bullet resistant panel 20 may be incorporated into other everyday items, which may be employed as a ballistic barrier wherein weight and size is an important factor.

Having thus described various embodiments of the present invention, it will now be evident that many modifications and additions are contemplated. Accordingly, the scope hereof is limited only by the appended claims and their equivalents.

What is claimed is:

1. A bullet resistant bag containing at least one panel comprising a stack of flexible unidirectional layers wherein each unidirectional layer contains a plurality of essentially parallel strong fibers and wherein certain unidirectional layers are arranged such that the strong fibers in adjacent layers are arranged at an angle to one another.

2. The bullet resistant bag of claim 1, wherein the stack of flexible unidirectional layers is comprised of ultra high molecular weight polyethylene.

3. The bullet resistant bag of claim 1, wherein certain adjacent unidirectional layers are arranged at ninety degrees to one another.

4. The bullet resistant bag of claim 1, wherein the panel is lighter than an equivalent ballistic stopping/rated KEVLAR panel.

5. The bullet resistant bag of claim 1, wherein the bag is a backpack.

6. The bullet resistant bag of claim 1, wherein the at least one panel is removably connected to an interior panel of the bag.

7. A bullet resistant cushion comprising at least one panel comprising a stack of flexible unidirectional layers wherein each unidirectional layer contains a plurality of essentially parallel strong fibers and wherein certain unidirectional layers are arranged such that the strong fibers in adjacent layers are arranged at an angle to one another.

8. A briefcase comprising at least one panel comprising a stack of flexible unidirectional layers wherein each unidirectional layer contains a plurality of essentially parallel strong fibers and wherein certain unidirectional layers are arranged such that the strong fibers in adjacent layers are arranged at an angle to one another.
